(19) United States
(12) Patent Application Publication
(10) Pub. No.: US 2025/0363410 A1
(43) Pub. Date: Nov. 27, 2025

(54) MODEL GENERATION SYSTEM AND MODEL GENERATION METHOD

(71) Applicant: Hitachi High-Tech Corporation, Minato-ku, Tokyo (JP)

(72) Inventors: Takeshi NAKAYAMA, Tokyo (JP); Takeshi OHMORI, Tokyo (JP)

(21) Appl. No.: 18/690,540

(22) PCT Filed: Feb. 20, 2023
(86) PCT No.: PCT/JP2023/005944

§ 371 Date: Mar. 8, 2024

(51) Int. Cl. G06N 20/00

(52) U.S. Cl. CPC G06N 20/00

(57) ABSTRACT

A model generation system includes: a source model database 12 that stores a source model; and a model generation unit 11 configured to generate the target model using the source model searched from the source model database. The model generation unit includes a database search unit configured to search for a first source model 31 including an output of the target model as an output thereof and a second source model 32 including an input of the target model as an input thereof, and a combination determination unit configured to combine, when association between an input of the first source model and an output of the second source model is available, the input of the first source model and the output of the second source model.

### TECHNICAL FIELD

The present invention relates to a model generation system and a model generation method.

### BACKGROUND ART

With progress of information processing techniques in recent years, machine learning techniques have been used in various fields. Machine learning is a method or a technique for constructing a learning model (also simply referred to as a “model”) based on a large amount of data or experience such as a certain rule and executing some tasks using the learning model.

Generally, in the machine learning, as the amount of data used for learning (referred to as “learning data” or “training data”) increases, a trained model with high accuracy can be implemented. Conversely, when the amount of data is small, it is difficult to construct a trained model with sufficient accuracy. Therefore, when a learning model is to be constructed, a trained model with sufficient accuracy can be obtained when a large amount of learning data is obtained, but only a trained model with insufficient accuracy can be obtained when the amount of learning data is small.

In a field of machine learning techniques, transfer learning is used as a method for obtaining a model with high accuracy using a small amount of data. The transfer learning is a generic term of a technique for achieving sufficient accuracy even when the amount of learning data is small by using (transferring) a trained model created using other learning data. In the transfer learning, attempts are made to obtain a model with high accuracy by a method such as reusing an existing trained model as it is, re-learning (“fine tuning” and the like) using the trained model as an initial value, or constructing, as a part of a target model, a new model incorporated by using the trained model as a partial model (source model). For example, PTL 1 discloses a method for selecting a trained model used for transfer learning.

### CITATION LIST

### Patent Literature

PTL 1: JP2021-182329A

### SUMMARY OF INVENTION

### Technical Problem

When a transfer learning method is used, it is expected to reduce preparation and calculation cost of a data set required for model construction by using a trained model created in the past when a large-scale and complicated model construction is performed.

On the other hand, various trained models have been constructed in accordance with advanced manufacturing techniques and commoditization of machine learning techniques. Therefore, the inventors have studied to generate a desired trained model by combining a plurality of trained models represented by a black box model such as a neural network (NN) and integrating the models into one model. Accordingly, it is possible to obtain a model with high prediction accuracy while ensuring development efficiency (a calculation amount and time required for learning) in model development. Further, the prediction accuracy can be further improved by training (transfer learning) the learning model to which the trained model is combined.

An object of the invention is to make it possible to generate a learning model by efficiently utilizing a trained model, a partial model, a known physical equation, and the like, which are similar in the past, without overlooking the above models, particularly in development of a new model using a transfer learning method.

### Solution to Problem

A model generation system according to an embodiment of the invention is a model generation system that generates a target model. The model generation system includes: a source model database that stores a source model; and a model generation unit configured to generate the target model using the source model searched from the source model database. The model generation unit includes a database search unit configured to search for a first source model including an output of the target model as an output thereof and a second source model including an input of the target model as an input thereof, and a combination determination unit configured to combine, when association between an input of the first source model and an output of the second source model is available, the input of the first source model and the output of the second source model. The source model stored in the source model database includes a trained machine learning model.

### Advantageous Effects of Invention

Learning cost (data collection cost, calculation cost) required for model generation is reduced. Other problems and novel features will be clarified from the description of the present specification and the accompanying drawings.

### BRIEF DESCRIPTION OF DRAWINGS

FIG. 1 is a diagram showing a basic configuration of a model generation system.

FIG. 2 is an example of processing of a processing device predicted by a machine learning model.

FIG. 3 is an example of a model generated in Embodiment 1.

FIG. 4 is a hardware configuration example of an information processing device.

FIG. 5 is an example of a program and data stored in a storage device in Embodiment 1.

FIG. 6 is a flowchart showing processing of generating a model by the model generation system in Embodiment 1.

FIG. 7 is an example of a model generated in Embodiment 2.

FIG. 8 is an example of a program and data stored in a storage device in Embodiment 2.

FIG. 9 is a flowchart showing processing of generating a model by a model generation system in Embodiment 2.

FIG. 10 is an example of a model generated in Embodiment 3.

FIG. 11 is an example of a program and data stored in a storage device in Embodiment 3.

### DESCRIPTION OF EMBODIMENTS

Hereinafter, embodiments of the invention will be described with reference to the drawings. The invention is not to be construed as being limited to the description of the embodiments described below. It will be easily understood by those skilled in the art that the specific configuration can be changed without departing from the spirit or scope of the invention. In order to facilitate understanding of the invention, the position, size, shape, and the like of each configuration shown in the drawings and the like in the present specification may not represent the actual position, size, shape, and the like. Accordingly, the invention is not limited to the positions, sizes, shapes, and the like disclosed in the drawings and the like.

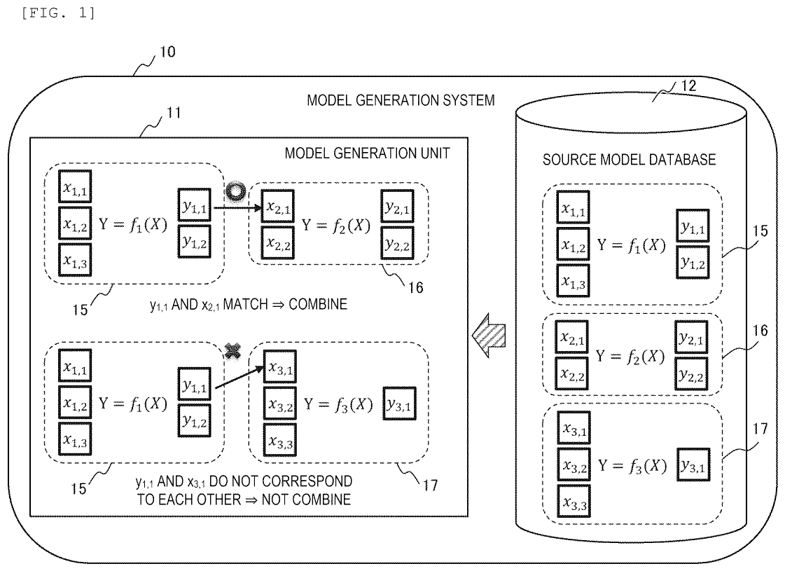

A basic configuration of a model generation system 10 according to the embodiment will be described with reference to FIG. 1. The model generation system 10 includes a model generation unit 11 and a source model database 12.

The source model database 12 stores a source model used for constructing a target model. The source model stored in the database 12 includes a trained machine learning model (hereinafter, referred to as a trained model), and an equation and inequality. A form of the machine learning model is not limited, and includes a neural network (NN), a gradient boosting tree, a linear regression, a kernel ridge method, and the like. In addition, the equation and inequality may be any equation and inequality that explains a phenomenon, and includes, for example, various equations such as a newtonian motion equation (F=ma) and a langmuir adsorption isotherm (K=Nθ/N(1−θ)p), and various inequalities such as a chebyshev inequality and a clausius inequality. In addition, the equation and inequality may be an equation and an inequality defined by a user. However, in the equation stored in the source model database 12, one parameter of the equation is set as an output Y (objective variable) and all the remaining parameters are set as an input X (explanatory variable or constant) such that a value of the objective variable is uniquely determined. The user can freely determine which parameter is the output Y. In addition, in the inequality stored in the source model database 12, all parameters of the inequality can be set as the input X, and information (Boolean value) of 1 or 0 indicating whether the inequality is satisfied can be set as the output Y. When the inequality has an equal sign establishment condition, it is also possible to set the inequality in the same manner as the equation, that is, to set one parameter as the output Y.

The model generation unit 11 performs a combination of the trained models and a combination of the equations and inequalities stored in the source model database 12. The source model has one or more inputs X and outputs Y. The model generation unit 11 checks item names of the inputs X and the outputs Y of different source models, and combines the inputs X and the outputs Y when the item names can be associated with each other.

FIG. 1 shows an example in which trained models 15 to 17 are stored in the source model database 12. For example, since an output y_{1,1} of the trained model 15 matches an input x_{2,1} of the trained model 16, the model generation unit 11 combines the output y_{1,1} and the input x_{2,1}. In addition, for example, since the output y_{1,1} of the trained model 15 and an input x_{3,1} of the trained model 17 cannot be associated with each other, the model generation unit 11 does not combine the output y_{1,1} and the input x_{3,1}. The case where the item names can be associated with each other in the model generation unit 11 includes a case where the item names match each other and a case where any correspondence relationship between the item names is recognized. A specific method for determining whether the combination is available will be described later.

As a rule of combination using the model generation unit 11, it is assumed that one output Y of the source model can be combined to inputs X of a plurality of other source models, whereas one input X of the source model can be combined to only one output Y of the other source models. In addition, basically, the inputs and outputs of the plurality of source models cannot be combined in a loop.

### Embodiment 1

In Embodiment 1, an example is shown in which one model is constructed by using a first trained model, which is obtained by training, by data acquired by actually operating the processing device, a machine learning model for predicting a processing result of a processing device, and a second trained model, which is obtained by training a result obtained by simulating a physical phenomenon occurring in the processing device by computer software, and using the model generation system of the embodiment.

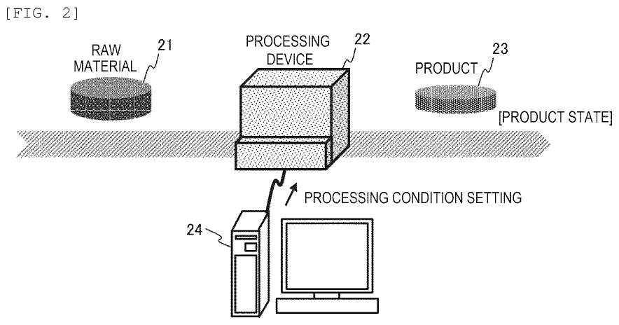

As shown in FIG. 2, a product 23 is obtained by charging a raw material 21 into a processing device 22. Here, a state of the product 23 depends on a processing condition set by a control computer 24 for the processing device 22. Therefore, the raw material 21 is actually processed by the processing device 22 by comprehensively varying processing conditions that can be set in the processing device 22, a large amount of learning data related to what kind of product 23 is obtained in each processing condition is acquired, and training of a machine learning model (for example, a neural network model) is performed, thereby obtaining a trained model that predicts a product state with certain accuracy based on the processing conditions.

However, since the processing device 22 normally requires a long time to process the raw material 21, a long time is required to obtain a large amount of new learning data. Therefore, in the model generation system according to the embodiment, by utilizing knowledge and a simulation technique obtained in the past, a method for obtaining a machine learning model capable of predicting the product state without obtaining new learning data is described.

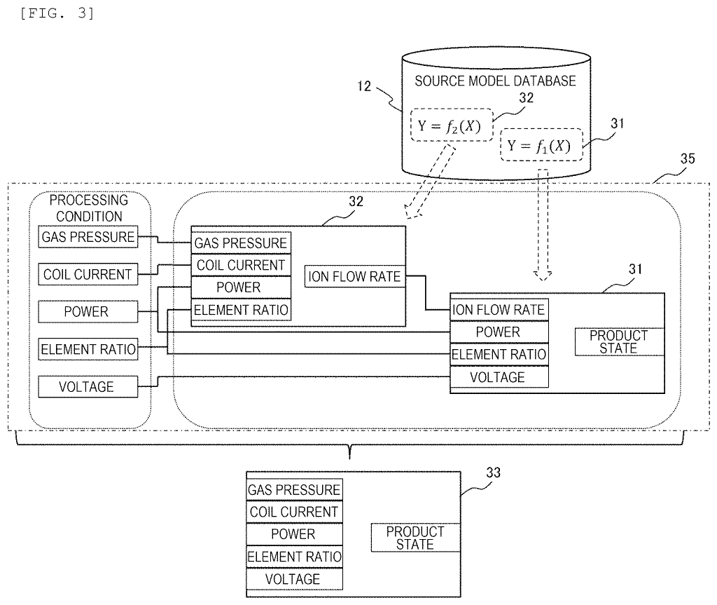

For example, as shown in FIG. 3, the user intends to construct a target model 33 in which five control parameters of a “gas pressure”, a “coil current”, a “power”, an “element ratio”, and a “voltage”, which are independent processing conditions of the processing device 22, are the inputs X, and the “product state” of the product 23 is the output Y. In addition, a first source model 31 and a second source model 32 are stored in the source model database 12. The first source model 31 is a trained model in which training is performed using, as the learning data, the product state of the product 23 obtained by causing the processing device 22 to process the raw material 21 by comprehensively varying three control parameters of a “power”, an “element ratio”, and a “voltage” in addition to an “ion flow rate” in the processing device 22. The ion flow rate in the device can be measured by providing a measuring instrument in the processing device 22. The first source model 31 in which four parameters of an “ion flow rate”, a “power”, an “element ratio”, and a “voltage” are the inputs X and a “product state” is the output Y is constructed through past experiments and the like, and is stored in the source model database 12. The second source model 32 is constructed using a physical simulation technique for a physical phenomenon in a processing chamber of the processing device 22, and is stored in the source model database 12. The second source model 32 is a trained model in which four control parameters of a “gas pressure”, a “coil current”, a “power”, and an “element ratio” are the inputs X and an “ion flow rate” is the output Y. In general, a calculation time required for the simulation is much shorter than the time required for the processing device 22 to actually process the raw material 21, and cost for acquiring the learning data can be reduced.

As described above, when the physical simulation is possible, a large amount of learning data can be prepared in a short time, and thus, for example, it is possible to generate a highly accurate trained model using machine learning such as deep learning. Since training is performed by a large amount of learning data, such a trained model is expected to predict the output Y (the “ion flow rate” in the case of the second source model 32) with high accuracy.

The model generation system 10 obtains the desired target model 33 by combining the first source model 31 and the second source model 32.

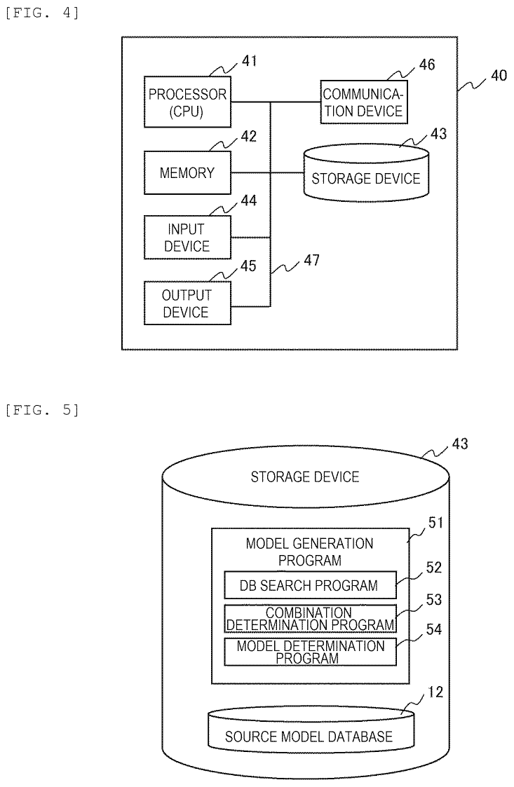

The model generation system 10 is implemented by an information processing device 40 including a processor (CPU) 41, a memory 42, a storage device 43, an input device 44, an output device 45, a communication device 46, and a bus 47 as main components as shown in FIG. 4. The processor 41 functions as a functional unit (functional block) that provides a predetermined function by executing processing according to a program loaded in the memory 42. The storage device 43 stores data to be used in functional units in addition to the program functions as the functional unit. As the storage device 43, for example, a nonvolatile storage medium such as a hard disk drive (HDD) or a solid state drive (SSD) is used. The input device 44 is a keyboard, a pointing device, and the like. The output device 45 is a display and the like. The communication device 46 can communicate with another information processing device via a network. These components are communicably connected to each other via the bus 47.

The model generation system 10 does not need to be implemented by one information processing device, and may be implemented by a plurality of information processing devices. In addition, a part or all of the functions of the model generation system 10 may be implemented as applications on a cloud.

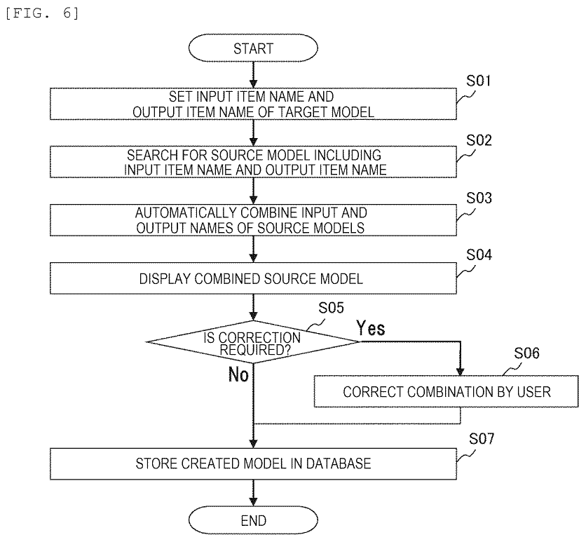

FIG. 5 shows programs and data stored in the storage device 43. A model generation program 51 is loaded into the memory 42 and executed by the processor 41 to cause the processor 41 to function as the model generation unit 11. The model generation program 51 includes a database (DB) search program 52, a combination determination program 53, and a model determination program 54 as sub-programs. These sub-programs are also loaded into the memory 42 and executed by the processor 41 to cause the processor 41 to function as a DB search unit, a combination determination unit, and a model determination unit. In addition, the source model database 12 used by the model generation system is also stored in the storage device 43.

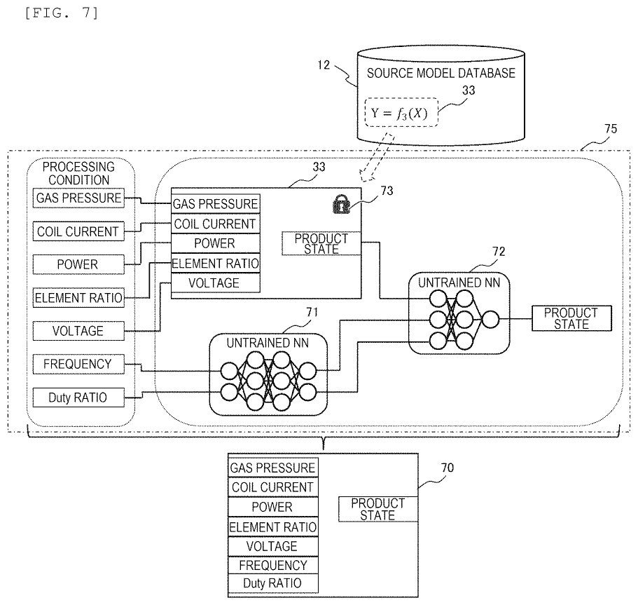

FIG. 6 is a flowchart showing processing of generating the target model 33 using the model generation system 10. First, the user sets an input item name and an output item name of a target model to be created (S01). In the example of FIG. 3, names of five control parameters (“gas pressure” and the like) as the inputs X of the model 33 and a parameter (“product state”) as the output X are set.

Subsequently, the DB search unit searches the source model database 12 for a source model including an input item name equal to the set input item name and a source model including an output item name equal to the set output item name (S02). When there is a plurality of candidates, models may be presented to the user and selected, or the system may select a new model during an update time. In the example of FIG. 3, the second source model 32 having a “gas pressure” and the like as an input item name and an “ion flow rate” as an output item name and the first source model 31 having an “ion flow rate”, a “power”, and the like as an input item name and a “product state” as an output item name are searched for.

Subsequently, the combination determination unit combines the input and output names of the source models (S03). Here, as a simple example, an example of combination in which the input and output names match each other is shown. In the example of FIG. 3, since the output item name “ion flow rate” of the second source model 32 matches the input item name “ion flow rate” of the first source model 31, the output item name and the input item name are combined.

Subsequently, the model determination unit displays the combined source model on the output device 45 (S04). At this time, for example, a model combination diagram 35 including the model combination information as shown in a one-dot chain line frame of FIG. 3 is displayed on the output device 45. In the model combination diagram 35, an input node indicating the input X is displayed on a left side of each box indicating the source model, and an output node indicating the output Y is displayed on a right side of the box. Further, the input node (processing condition) indicating the input X of the target model is shown on the left side of the source model. A combination between the input node of the target model and the input node of the corresponding source model, and a combination between the nodes associated with each other in the source model are displayed by edges. As described above, in a display screen, a GUI having a layout, in which the input node is relatively located on the left side and the output node is relatively located on the right side, is displayed on the screen. Therefore, it is easy to check whether an inappropriate combination (for example, loop connection) is made between the source models.

The user checks the model combination diagram 35 displayed on the GUI screen (S05), and when correction is required, the user corrects the combination of the input node of the target model and the source model or the combination of the source models by manually correcting the edges of the model combination diagram 35 on the GUI screen (S06). The case where the correction is required includes, for example, a case where the combined nodes can be determined to be inappropriate from domain knowledge of the user. Thereafter, the completed target model 33 is stored in the source model database 12 (S07).

The model 33 created in this manner is created using only the trained model, and does not necessarily require additional learning, but it is recommended to perform additional training (referred to as additional learning) using the learning data if the learning data (here, the data set of the processing condition for the five control parameters of the target model 33 and the product state under the processing condition) is obtained even in a small amount. Setting a weight of an original trained model as an initial value, and updating the weight by the additional learning using a small amount of learning data is referred to as fine tuning. In general, it is known that the possibility of obtaining a more accurate learning model is increased by performing appropriate fine tuning. When fine tuning is performed, hyper parameters such as a learning rate of each model may be appropriately set by the user.

### Embodiment 2

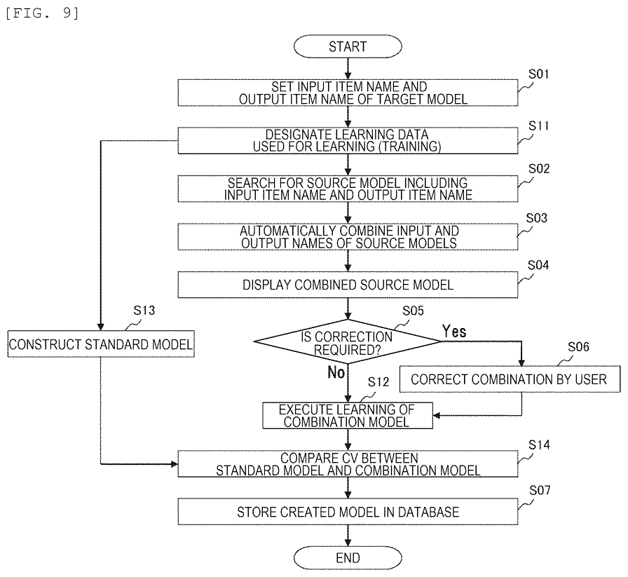

In Embodiment 2, not only a trained model, an equation, and an inequality but also an untrained machine learning model is utilized as a source model. The model generation system 10 according to Embodiment 2 is also implemented by the information processing device 40 as shown in FIG. 4. FIG. 8 shows programs and data stored in the storage device 43. In addition to the programs and data stored in Embodiment 1 (FIG. 5), a machine learning program 81 for performing machine learning is stored. The machine learning program 81 is loaded into the memory 42 and executed by the processor 41 to cause the processor 41 to function as a machine learning unit. The machine learning program 81 includes a model setting program 82 and a learning (training) program 83 as sub-programs. These sub-programs are also loaded into the memory 42 and executed by the processor 41 to cause the processor 41 to function as a model setting unit and a learning unit.

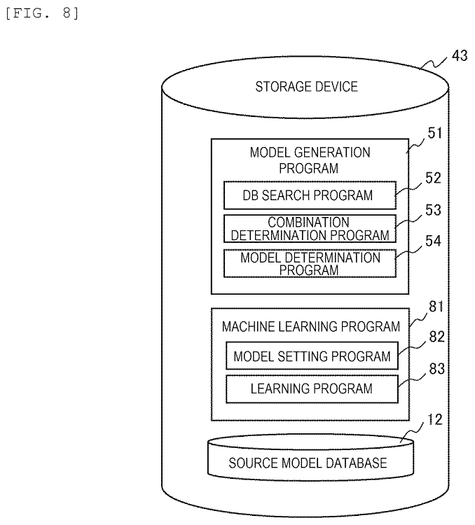

In the example of FIG. 7, a target model 70 in which the number of the inputs X (control parameters) is increased is created in order to further improve the accuracy of the model 33 created in Embodiment 1. The untrained machine learning model is used as a source model. Specifically, the input X of the target model 70 is obtained by adding two control parameters of a “frequency” and a “duty ratio” to the input X of the model 33.

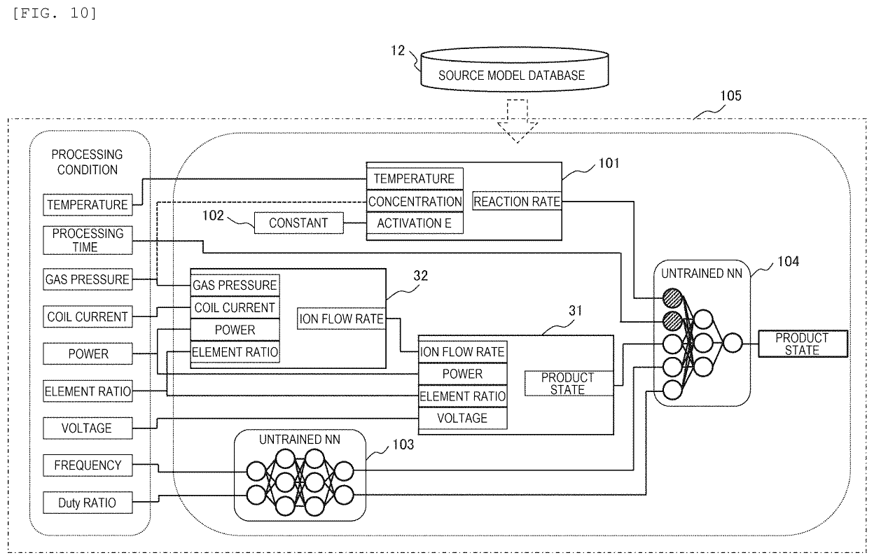

FIG. 9 is a flowchart showing processing of generating the target model 70 using the model generation system 10. The same processing as those in FIG. 6 are denoted by the same reference numerals, and redundant description will be omitted, and differences will be mainly described. First, the user sets an input item name and an output item name of a target model to be created (S01). In the example of FIG. 7, names of seven control parameters (“gas pressure” and the like) as the inputs X of the target model 70 and a parameter (“product state”) as the output X are set.

Subsequently, the user designates learning data to be used for learning (training) of a model (S11). Since this example is a regression problem, the product state of the product 23, which is obtained by causing the processing device 22 to process the raw material 21 by comprehensively varying seven control parameters serving as the input X of the target model 70, is used as the learning data. The learning data, which is a combination of the seven control parameters and the product state, is given, for example, in a form of a csv file. Thereafter, step S02 and step S13 are performed in parallel.

In step S02, the DB search unit searches the source model database 12, and the model 33 is searched for. In step S03, the combination determination unit combines input and output names of a source model. In this example, the number of models searched from the source model database 12 is one. When two or more models are searched for, the same processing as in Embodiment 1 is performed.

Subsequently, the model determination unit displays the combined source model on the output device 45 (S04). In Embodiment 2, a model combination diagram 75 including model combination information as shown in a one-dot chain line frame of FIG. 7 is displayed on the output device 45. At this time, only the searched source model 33 is displayed on the output device 45, and a “frequency” node and a “duty ratio” node are not connected to anywhere.

The user checks the model combination diagram 75 displayed on the GUI screen (S05), and manually corrects the model combination diagram 75 on the GUI screen (S06) because there is an unconnected processing condition. Here, two untrained models 71 and 72 are added, and the source models are combined to each other in accordance with the desired target model 70. A method for adding and combining the untrained model is not limited to the example of FIG. 7.

Subsequently, the machine learning unit executes learning of a model (referred to as a “combination model”) that is a combination of the source model 33 and the untrained models 71 and 72 using the learning data designated in step S11 (S12).

The model setting unit allows the user to define an input and output and set hyper parameters for the untrained models 71 and 72 added on the GUI screen. For example, when a neural network (NN) model is used as the untrained model, various hyper parameters including the number of layers and the number of nodes can be set in detail directly by the user, or can be automatically determined by a program for performing Bayesian optimization. In addition, when Bayesian optimization is performed, detailed setting of a range in which optimization is performed is also possible.

The learning unit causes the combination model to perform learning by the learning data. Regarding the learning (training) of the combination model, for example, when it is determined that the accuracy of the source model 33 is high to some extent or the amount of learning data designated in step S11 is small, it is recommended that the learning rate of the source model 33 is set to 0 and weighting inside the source model 33 is not updated in the learning in step S12. In such a case, the user turns on a lock icon 73 displayed on the upper right of the corresponding source model on the GUI screen. When the lock icon 73 of the source model 33 is turned on in the learning of the combination model, the learning unit does not update the weighting. This state is referred to as a “source fixed mode”.

Regarding this, when the lock icon 73 is turned off, the learning unit performs update including the weighting of the source model 33 in the training of the combination model. This state is referred to as a “fine tuning mode”, and for example, the additional learning described in Embodiment 1 is performed in the fine tuning mode.

On the other hand, the machine learning unit constructs a model (referred to as a “standard model”) in which desired seven control parameters are set as the inputs X and the “product state” is set as the output Y (S13). The model setting unit defines the input and output of the standard model and causes the user to set hyper parameters for the standard model. The learning unit causes the standard model to perform learning by the learning data.

The learning of the model using the learning data (steps S12 and S13) may take several hours to several days depending on the amount of data and specifications of the information processing device (computer).

When the learning of the standard model and the combination model is completed, the model determination unit compares cross validation (CV) results of the two models during the learning of the models by the learning unit using a part of the learning data (S14). The model determination unit determines which model can perform prediction with higher accuracy based on a CV value, selects the model determined to have higher accuracy as the target model 70, and stores the selected model in the source model database 12 (S07).

### Embodiment 3

Embodiment 3 is an example of constructing a model including more processing conditions as the input X, and an example of utilizing a physical equation stored in the source model database 12 will be described. In addition, a method for combining nodes whose item names do not completely match will also be described. The model generation system 10 according to Embodiment 3 is also implemented by the information processing device 40 as shown in FIG. 4. FIG. 11 shows programs and data stored in the storage device 43. In addition to the programs and data stored in Embodiment 2 (FIG. 8), a synonym dictionary 112 and a node combination history 113 are stored. In addition, the combination determination program 53 includes a text mining program 111 as a sub-program. The text mining program 111 is also loaded into the memory 42 and executed by the processor 41 to cause the processor 41 to function as a text mining unit.

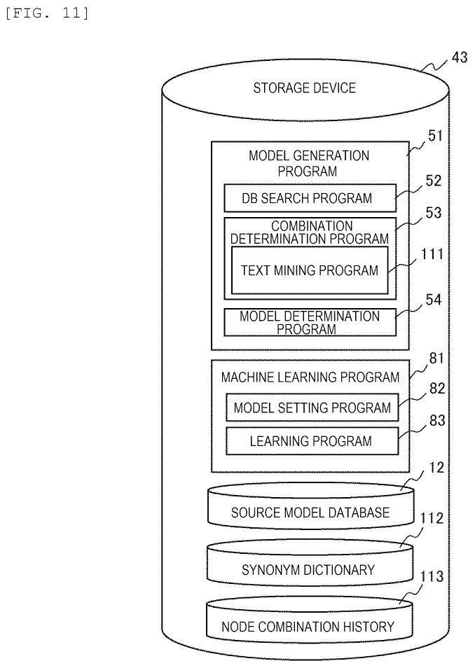

In the example of FIG. 10, a model, in which the number of the inputs X (control parameters) is further increased than that of the model created in Embodiment 2, is created in order to further improve the accuracy, and an untrained machine learning model and a physical equation are used as a source model. Specifically, the input X of the model created in Embodiment 3 is obtained by adding two control parameters of a “temperature” and a “processing time” to the input X of the model 70.

The two control parameters are added based on domain knowledge of the user. For example, it is assumed that, as the processing time becomes longer, some influence proportional to time is exerted on the product state. Further, when a reaction rate of a chemical reaction assumed to occur during the processing is known, it can be estimated that a product of the reaction rate and the processing time greatly influences the product state.

The processing of generating a model using the model generation system 10 is the same as the flowchart shown in FIG. 9. Feature points will be mainly described. First, the user sets an input item name and an output item name of a target model to be created (S01). In the example of FIG. 10, names of nine control parameters (“gas pressure” and the like) as the inputs X of a desired target model and a parameter (“product state”) as the output X are set. In subsequent step S02, the DB search unit searches the source model database 12, and the first source model 31 and the second source model 32 are searched for. In step S03, the combination determination unit combines the first source model 31 and the second source model 32. In step S04, the model determination unit displays the combined source model on the output device 45. In Embodiment 3 as well, a model combination diagram 105 including model combination information as shown in a one-dot chain line frame of FIG. 10 is displayed on the output device 45. At this time, only the searched source models 31 and 32 are displayed on the output device 45, and a “temperature” node, a “processing time” node, a “frequency” node, and a “duty ratio” node are not connected to anywhere.

The user checks the model combination diagram 105 displayed on the GUI screen (S05), and manually corrects the model combination diagram 105 on the GUI screen (S06) because there is an unconnected processing condition. First, as in Embodiment 2, two untrained models 103 and 104 are added, and the source models are combined to each other in accordance with the desired target model. At this stage, the “temperature” node and the “processing time” node remain unconnected.

As described above, in order to construct a model for predicting a product state, it is considered that the user wants to use concepts of a “processing time”, which is one of the processing conditions, and a “reaction rate” of the chemical reaction during the processing, based on the domain knowledge related to the processing device 22. Therefore, two parameters of a “reaction rate” and a “processing time” are manually fixed to input items of the untrained model 104 in the final stage shown in FIG. 10. The “processing time” is one of the parameters that are the inputs X of the target model, but the “reaction rate” is an intermediate node that is neither an input node nor an output node of the target model.

At this time, since the “temperature” node and the “reaction rate” node remain as unconnected nodes, the user searches the source model database 12 for the source model having the item names. Accordingly, an Arrhenius equation (reaction rate k=Aexp(−E/RT)), which is a physical equation, is displayed on the GUI screen as a source model candidate. The Arrhenius equation is a general relational expression (equation) representing a correlation among parameters of a “reaction rate”, a “temperature”, a “concentration”, and an “activation energy (activation E)”. When the equation is used as the source model, it is necessary to assign one of the parameters to the output Y and assign the other parameters to the input X. Therefore, a source model 101 based on the Arrhenius equation is a source model in which the “reaction rate” is the output Y and the “temperature”, the “concentration”, and the “activation E” are the inputs X. As a result, the combination determination unit combines the “temperature” node among the inputs X of the source model 101 to the “temperature” node, which is the processing condition, and combines the “reaction rate” node which is the output Y of the source model 101 to the input node of the untrained model 104 to which the “reaction rate” is assigned. Accordingly, the “concentration” node and the “activation E” node among the inputs X of the source model 101 remain unconnected.

Since all the input nodes of the source model are connected to some number of nodes, the combination determination unit activates the text mining program 111. The text mining unit searches the synonym dictionary 112 or the node combination history 113, and automatically executes a search related to the “concentration” and the “activation E”. For example, a history, in which the “concentration” node and the “pressure” node are manually combined based on domain knowledge that “a collision frequency of gas molecules increases and a local molecular concentration substantially related to a chemical reaction increases as a pressure increases” in the past, remains in the node combination history 113. The combination determination unit combines the “concentration” node and the “gas pressure” node based on the information searched by the text mining unit. On the other hand, since an automatic combination by the combination determination unit is not performed on the “activation E” node of the source model 101, a constant node 102 is set, and a constant is input from the constant node 102 to the source model 101, thereby completing the combination correction between the source models.

Here, an example is shown in which the synonym dictionary 112 and the node combination history 113 are searched in a search of a combination destination, and a method for estimating the combination destination using unit dimensional information allocated to each node is also useful. For example, for a pressure (Pa), similarity or non-similarity between units can be evaluated using a fact that the pressure can be expressed as m⁻¹·kg·s⁻² using an SI unit system. Further, an item association table may be provided in which item names for which the user permits the combination of nodes are stored in advance.

In addition, it is also possible to search the source model database 12 not only for the search of the combination destination but also for the similarity of node names and the combination history (step S02). In this case, since a large number of source models are searched for, for example, it is desirable to assign priorities based on the number of corresponding variables and present the priorities to the user.

A plurality of embodiments of the model generation system have been described above. A plurality of components disclosed in the above embodiments can be appropriately combined as long as there is no contradiction in the combination. Further, some components can be deleted from all the components shown in the above embodiments.

### REFERENCE SIGNS LIST

10: model generation system
11: model generation unit
12: source model database
15 to 17: trained model
21: raw material
22: processing device
23: product
24: control computer
31: first source model
32: second source model
33: model
35: model combination diagram
40: information processing device
41: processor (CPU)
42: memory
43: storage device
44: input device
45: output device
46: communication device
47: bus
51: model generation program
52: database search program
53: combination determination program
54: model determination program
70: model
71, 72: untrained model
73: lock icon
75: model combination diagram
81: machine learning program
82: model setting program
83: learning program
101: source model
102: constant node
103, 104: untrained model
105: model combination diagram
111: text mining program
112: synonym dictionary
113: node combination history

1. A model generation system that generates a target model, the model generation system comprising:
a source model database that stores a source model; and
a model generation unit configured to generate the target model using the source model searched from the source model database, wherein
the model generation unit includes
a database search unit configured to search for a first source model including an output of the target model as an output thereof and a second source model including an input of the target model as an input thereof, and
a combination determination unit configured to combine, when association between an input of the first source model and an output of the second source model is available, the input of the first source model and the output of the second source model, and
the source model stored in the source model database includes a trained machine learning model.

2. The model generation system according to claim 1, wherein
the model generation unit includes a model determination unit,
the model determination unit displays, on a GUI screen, a model combination diagram indicating an input node indicating the input of the target model, and the first source model and the second source model,
the model combination diagram connects the input node of the target model to an input node indicating the input of the corresponding first source model or the second source model by an edge, and connects an output node indicating the output of the second source model to the input node indicating the input of the corresponding first source model by an edge, and
the model determination unit corrects, on the GUI screen, a combination of the input of the target model and the input of the first source model or the second source model and a combination of the output of the second source model and the input of the first source model according to corrected connection when the connection by the edges in the model combination diagram is corrected.

3. The model generation system according to claim 2, wherein
the combination determination unit determines that the association is available when an item name of the input of the first source model and an item name of the output of the second source model match, when the item name of the input of the first source model and the item name of the output of the second source model are synonyms, when there is a combination history between the item name of the input of the first source model and the item name of the output of the second source model, or when it is determined that unit dimensional information of the input of the first source model and unit dimensional information of the output of the second source model are similar.

4. The model generation system according to claim 1, wherein
the source model stored in the source model database includes an equation or an inequality having an equal sign establishment condition, and
the source model representing the equation or the inequality is defined by using one parameter of the equation or the inequality as an output and another parameter as an input.

5. The model generation system according to claim 1, wherein
the source model stored in the source model database includes an inequality, and
the source model representing the inequality is defined by using a Boolean value indicating whether the inequality is satisfied as an output and using all parameters as an input.

6. A model generation system that generates a target model, the model generation system comprising:
a source model database that stores a source model;
a model generation unit configured to generate the target model from the source model searched from the source model database; and
a machine learning unit configured to perform machine learning, wherein
the model generation unit includes a model determination unit, and a database search unit configured to search for a first source model including an output of the target model as an output thereof and a second source model including an input of the target model as an input thereof,
the model determination unit displays, on a GUI screen, a model combination diagram that includes an input node indicating the input of the target model and one or more search source models searched by the database search unit, and that connects corresponding input nodes or an output node of a certain search source model and an input node of another corresponding search source model by an edge,
when connection of the model combination diagram is corrected to add an untrained model to the GUI screen, the model determination unit determines a combination model in which the input of the target model and a combination of the search source model and the untrained model are corrected according to the corrected connection, and
the machine learning unit performs training of the combination model using learning data corresponding to the input and the output of the target model.

7. The model generation system according to claim 6, wherein
the machine learning unit sets a learning rate of the search source model included in the combination model to 0 in the training of the combination model.

8. The model generation system according to claim 6, wherein
the machine learning unit sets a standard model that is a machine learning model using the input of the target model as an input and the output of the target model as an output, and performs training of the standard model using the learning data, and
the model determination unit selects one of the combination model and the standard model as the target model.

9. The model generation system according to claim 6, wherein
the model generation unit includes a combination determination unit,
the search source model includes the first source model including the output of the target model as the output thereof, and the second source model including the input of the target model as the input thereof,
the combination determination unit combines, when association between an input of the first source model and an output of the second source model is available, the input of the first source model and the output of the second source model,
the model combination diagram connects the input node of the target model to an input node indicating the input of the corresponding first source model or the second source model by an edge, and connects an output node indicating the output of the second source model to the input node indicating the input of the corresponding first source model by an edge, and
the model determination unit corrects, on the GUI screen, a combination of the input of the target model and the input of the first source model or the second source model and a combination of the output of the second source model and the input of the first source model according to corrected connection when the connection by the edges in the model combination diagram is corrected.

10. The model generation system according to claim 9, wherein
the combination determination unit determines that the association is available when an item name of an input of the certain search source model and an item name of an output of the another search source model match, when the item name of the input of the certain search source model and the item name of the output of the another search source model are synonyms, when there is a combination history between the item name of the input of the certain search source model and the item name of the output of the another search source model, or when it is determined that unit dimensional information of the input of the certain search source model and unit dimensional information of the output of the another search source model are similar.

11. The model generation system according to claim 6, wherein
the source model stored in the source model database includes an equation or an inequality having an equal sign establishment condition, and
the source model representing the equation or the inequality is defined by using one parameter of the equation or the inequality as an output and another parameter as an input.

12. The model generation system according to claim 6, wherein
the source model stored in the source model database includes an inequality, and
the source model representing the inequality is defined by using a Boolean value indicating whether the inequality is satisfied as an output and using all parameters as an input.

13. A model generation method for generating a target model by using a model generation system, wherein
the model generation system includes a source model database that stores a source model, and a model generation unit configured to generate the target model using the source model searched from the source model database,
the model generation unit
searches for a first source model including an output of the target model as an output thereof and a second source model including an input of the target model as an input thereof, and
combines, when association between an input of the first source model and an output of the second source model is available, the input of the first source model and the output of the second source model, and
the source model stored in the source model database includes a trained machine learning model.

14. The model generation method according to claim 13, wherein
the model generation unit
displays, on a GUI screen, a model combination diagram indicating an input node indicating the input of the target model, and the first source model and the second source model, the model combination diagram connecting the input node of the target model to an input node indicating the input of the corresponding first source model or the second source model by an edge, and connecting an output node indicating the output of the second source model to the input node indicating the input of the corresponding first source model by an edge, and
corrects, on the GUI screen, a combination of the input of the target model and the input of the first source model or the second source model and a combination of the output of the second source model and the input of the first source model according to corrected connection when the connection by the edges in the model combination diagram is corrected.
